(19) United States
(12) Patent Application Publication
(10) Pub. No.: US 2011/0287134 A1
(43) Pub. Date: Nov. 24, 2011

(54) CHOCOLATE DIETARY FIBER SUPPLEMENT AND DELIVERY METHOD

(76) Inventors: Gary Ervin, Naples, FL (US); Erin Ervin, Naples, FL (US)

(21) Appl. No.: 13/110,805

(22) Filed: May 18, 2011

Related U.S. Application Data
(60) Provisional application No. 61/345,716, filed on May 18, 2010.

(51) Int. Cl. A23G 1/48; A23L 1/308

(52) U.S. Cl. 426/2; 426/631

(57) ABSTRACT

Chocolate or compound coating based fiber compositions, which have at least about 20% of a fiber component, by weight of the formula, that provide a safe and effective amount of fiber component to a user are disclosed. This delivery method can utilize either a bulk forming fiber like psyllium, or a non-bulk forming fiber like inulin or a combination of both types of fiber components. The fiber easily can be incorporated into the compositions without adversely affecting the stability, feel, and taste of the compositions. The nutritional profiles of these fiber compositions are consistent with dietary guidelines, which physicians follow when prescribing fiber compositions as supplements or for cholesterol reduction purposes. Also disclosed is a method of producing such compositions and a method of providing a safe and effective amount of fiber component to a user.

### RELATED APPLICATIONS

The present application claims priority to U.S. Patent Application Provisional application No. 61/345,716, filed on May 18, 2010, the disclosure of which is incorporated by reference herein in its entirety.

### BACKGROUND

1. Field of the Invention

The embodiments described herein relate generally to ingestible compositions based on a standardized or compound coating chocolate or white chocolate primary component, and more particularly to compositions that deliver fiber to a mammal, and to methods of making and using such composition.

2. Description of Related Art

U.S. Pat. No. 4,582,709, issued to Peters et al. on Apr. 15, 1986, discloses pleasant tasting, soft, chewable mineral supplements based upon caramel or nougat confectionery compositions. Troller (Water Activity and Food) discloses confectioneries protected from microbial spoilage by controlling the water activity. The water activity is controlled to prevent microbial spoilage, particularly due to yeast fermentation. U.S. Pat. No. 4,766,004, to Moskowitz, issued Aug. 23 1988 (describes dietary fiber supplement compositions comprising whole psyllium husks having a particle size of from 12 to 70 mesh, food grade vegetable fat which is solid at room temperature, sweetening agent and flavoring agent);U.S. Pat. No. 5,571,441, issued to Andon et al. on Nov. 5, 1996, discloses vitamin supplements containing bracers and flavanols or green tea solids and possibly carbohydrates. U.S. Pat. No. 5,223,264, issued to Wehling et al. on Jun. 29, 1993, discloses the addition of the mineral magnesium phosphate to products as a dietary supplement. U.S. Pat. No. 6,740,350, issued May 25, 2004, discloses confectionery compositions containing fiber preferably in a “fiber chew” form.

U.S. Pat. No. 4,766,004, to Moskowitz, issued Aug. 23 1998 discloses the use of psyllium husk and an optional additional dietary fiber selected from fruit fibers, grain fibers, vegetable fibers, cellulose fibers, and water-soluble gums, such as corn bran, wheat bran, soy fiber, guar gum and mixtures thereof. The Moskowitz patent only includes cocoa butter or a fat composition made of fractionated palm kernel oil and a hydrogenated palm oil and a flavor such as cocoa. The compositions described in the Moskowitz patent do not include chocolate liquor that has the cocoa solids portion of the cocoa bean that isn't Cocoa powder used as chocolate flavor. Moreover, the fat compositions described in the Moskowitz patent exhibit a substantially higher level of saturated fat compared to compositions made within the present invention. These high levels of saturated fat present do not meet established dietary guidelines to qualify for “Dr. Recommended” or “heart healthy” status, where as the compositions described herein do qualify for such designations. In order for a product to make a heart healthy claim it must be low fat having 4 grams or less and low in saturated fat or 1 gram or less of saturated fat.

It is well-known that fiber is an important part of the diet of mammals, particularly humans. Medical and nutrition professionals generally agree that dietary fiber is essential for good human health. Too little fiber in the diet is associated with diseases such as heart disease, diabetes, obesity, and colon cancer. In addition, too little fiber often results in intestinal irregularity. Proper amounts of fiber in the diet stimulate bowel movement, slow down the gastrointestinal transition and digestion processes, modify fat absorption, and increase excretion of bile acids. In addition, some dietary fibers are known to lower blood cholesterol and benefit the postprandial (after eating) glycemic response. In addition, various types of fiber and/or fiber components, for example, moderately fermentable fiber that is fermented by the intestinal flora of a user, has been shown to promote the growth and/or development of lactic acid bacteria in the gastrointestinal tract of a user, at the expense of pathogenic bacteria, thus providing benefit to the user's gastrointestinal tract.

However, it has also been documented that the average person in the United States consumes about 15 grams of dietary fiber per day. Most health professionals recommend a dietary fiber intake of 25 grams for people with a diet of 2000 calories per day and 30 grams for people with a diet of 3000 calories per day. Thus, an extra 10 to 15 grams of fiber per day is needed to reach the recommended levels. Fiber intake can be increased by eating greater amounts of foods high in fiber such as grains, fruits, and vegetables. However, most consumers would have to almost double their intake of such foods to attain the recommended daily amount of fiber. Many consumers are unwilling or unable to eat large amounts of high fiber foods, and thus often look for supplements to provide the additional needed fiber.

Consumers often look to supplements to complement their diet when a dietary ingredient such as fiber is lacking. The Citrucel® brand of fiber from SmithKline Beecham (http://www.citrucel.com/) contains methylcellulose fiber that is promoted to “help you stay regular without excess gas.” The product is sold in varieties that include various fruit flavoring agents, citric acid, sucrose, and other compounds. A sugar-free product contains an artificial sweetener as well as natural fruit flavors. The Metamucil® brand of fiber from Procter and Gamble (http://www.metamucil.com/) contains psyllium fiber that is promoted as a product that “may help reduce heart disease risk by lowering cholesterol when part of a heart healthy diet.” The product is sold in varieties that include various fruit flavors and other inactives. Metamucil brand also offers fiber wafers that provide fiber supplementation in a food wafer format. This product is very dry, however, and tends to stick in the mouth, gets in your teeth and gums, and is very hard to swallow.

GlaxoSmithKline has a Fiber Choice brand of fiber supplements that incorporates inulin (a natural vegetable fiber), as the only fiber source and come in various fruit flavors and other actives. The prior art discloses other methods for supplementing dietary fiber. U.S. Pat. No. 5,073,370, issued to Meer et al. on Dec. 17, 1991, describes a natural fiber laxative containing psyllium husk, apple fiber, fructose, gum arabic, and flavorants. The psyllium husk and the apple fiber comprise at least 75% by weight of the composition. The particle size is controlled to improve palatability. U.S. Pat. No. 5,516,524, issued to Kais et al. on May 14, 1996, discloses an ingestible laxative composition comprising specified amounts of dioctyl sulfosuccinate and bulk fiber selected from the group consisting of psyllium, methylcellulose, polycarbophil, calcium polycarbophil, bran, malt soup extract, karaya, guar gum, and mixtures thereof. U.S. Pat. No. 4,321,263 issued to Powell et al. on Mar. 23, 1982, discloses psyllium-based bulk laxatives prepared from powdered husks of psyllium seeds and equal parts of a sugar wetting agent. The compositions are dispersed in water to provide hydrophilic aqueous compositions which adsorb large amounts of water to provide bulk and thus normalize bowel function by improving stool formation. U.S. Pat. No. 5,710,183, issued to Halow on Jan. 20, 1998, discloses a fiber composition containing polyethylene glycol. Polyethylene glycol is used as a wetting agent to promote dispersion in solvents. U.S. Pat. No. 6,740,350 issued to Pfeiffer, discloses a fiber composition made out of confectionery material and turned into chews. U.S. Pat. No. 6,455,068 issued Sep. 24, 2002, discloses a method for delivering soluble fiber in a chewable tablet form.

Fiber supplements available to consumers such as those discussed herein have generally consisted of inconvenient and unpalatable fiber compositions that must be dissolved in water and drunk or incorporated into food items and eaten. To date there are several types and brands of fiber supplements available including powders, tablets, capsules, biscuits, breakfast cereals, laxative beverages, and the like. However, many of these compositions have certain drawbacks and are not easily accepted by consumers due to factors including: a lack of portability, for example of powders or beverages; the unpleasant taste, and texture and/or mouthfeel of many fiber containing materials. Most of the fiber supplements also only offer one type of fiber either bulk forming or non bulk forming varieties. Such unpleasant and/or inconvenient properties often result in the user discontinuing use of the product.

Consumers would benefit from a fiber composition that delivers a supplement amount of non-bulk forming fiber, bulk forming fiber, or combinations of both types of fiber in a highly palatable, convenient, and enjoyable food supplement delivery format such that users would look forward to daily fiber supplementation. This would improve the likelihood of consumers continuing to comply with supplementation and thus addresses one of the major drawbacks to fiber supplementation, which is lack of ongoing consumer compliance with doctor directed fiber supplementation. Consumers often stop taking current fiber supplements that have been prescribed based on frustration over inconvenient product forms, poor taste and poor mouth feel of existing fiber supplements.

### SUMMARY OF INVENTION

It is, therefore, a feature of an embodiment of the invention to provide convenient and highly palatable standardized or compound coating chocolate or white chocolate-based compositions containing dietary fiber. It is another feature of an embodiment to include nutrition and saturated fat content in these compositions consistent with established dietary guidelines to qualify for “physician recommended” status. Below is a link to the 2005 USDA Healthy Diet Guidelines that describes the importance of unsaturated fats in the diet.

http://www.health.gov/DIETARYGUIDELINES/dga2005/document/html/chapter6.htm

The present embodiments make use of a unique changed structure for chocolate that allows the compositions to have low saturated fat and beneficial amounts of unsaturated fats including monounsaturated and polyunsaturated fats. Most major brands of fiber supplements currently available utilize doctor recommendations as a means to encourage consumers to use them. Metamucil®, marketed by Proctor & Gamble claims to be the #1 Doctor Recommended Fiber Supplement.

The fats and sugar levels present in the compositions of the various embodiments described herein are low in sugar and saturated fat, and are consistent with established dietary guidelines for heart healthy foods and Dr. Recommendations. Certain embodiments can create products that meet the FDA guidelines for heart healthy foods.

It is another feature of an embodiment to provide a fiber supplement, fiber laxative, or fiber food that can provide a therapeutic amount of a bulk forming fiber like whole psyllium husk in the range of 3.5 grams per serving unit of the composition or per two serving units of the composition to provide control of bowel function and or for reducing blood cholesterol levels and/or for weight control or other indications where fiber may be beneficial. It is a further feature of an embodiment to provide a method for providing supplementary dietary fiber to a consumer by having the user consume a convenient and palatable standardized or compound coating chocolate or white chocolate based composition containing this non-bulk forming or bulk forming fiber or combination of both types of fiber. Based on certain ratios of ingredients it is an additional feature of an embodiment to create a dietary fiber supplement that can claim status for being “Heart Healthy” as defined by the FDA.

These and other features and advantages of the embodiments can be achieved using confectionery standardized or compound coating chocolate or white chocolate compositions containing fiber. The compositions contain confectionery ingredients that make the composition palatable and fiber ingredients that supplement fiber in the diet when the compositions are consumed. The compositions may be available to the consumer in convenient, preferably bitesize, squares or rectangles of specific weight, varying molded shapes or sizes that are available for chocolate confectionery products, nutritional and snack bars including any and all categories within the nutritional and snack bar category (meal replacement, diet, energy, protein, breakfast, etc.) at specific weights, clusters, individual unit dose, user-dosable form, and mixtures thereof that can be easily consumed as a supplement. The confectionery ingredients can be present in the composition in amounts and ratios so that the fiber can be easily incorporated into the composition without adversely affecting the stability, texture, feel, taste, and aftertaste of the composition.

In accordance with these and other features of the embodiments, there is provided a composition comprising: a. at least about 20% wt. % of fiber selected from whole psyllium husks and inulin, or a single bulk forming fiber, or a single non-bulk forming fiber, or a mixture of other bulk forming and non bulk forming fibers; b. at least 40% wt. % of a standardized or compound coating chocolate or white chocolate component; and c. from about 0.001% to 15% wt. % of edible oils component. In more preferred embodiments, the compositions may further comprise: d. from about 0.001% to 20% wt. % of 100% Cocoa Powder component if utilizing a chocolate or compound coating chocolate; e. from about 0.001% to 20% wt. % of confectionery sugar component if utilizing a chocolate or compound coating chocolate; f. from about 0.001% to 15% wt. % of a crunchy texture ingredient component like crisp rice and chia seeds each alone or together, or another crunchy texture ingredient or combinations of crunchy texture ingredient components; and g. at least about 0% or greater of a supplement selected from the group consisting of: vitamins, minerals, herbs, botanicals, plant derived supplements, animal derived supplements, therapeutic compounds, and mixtures thereof; by weight of said composition.

In accordance with another embodiment, there is provided a composition comprising: a. at least about 20% of a fiber component, by weight of the composition; and b. at least 40% a standardized or compound coating chocolate or white chocolate component, by weight of the composition; and c. from about 0.001% to 15% of an edible oil component by weight of the composition. An additional embodiment provides a composition comprising: a. at least about 20% of a fiber component, by weight of the composition; b. at least 40% a standardized or compound coating chocolate or white chocolate component, by weight of the composition; c. from about 0.001% to 15% an edible oil component by weight of the composition; and d. from 0.001% to 20% a 100% cocoa component if utilizing a chocolate or compound coating chocolate, by weight of the composition.

Further embodiments provides compositions comprising the above components (a)-(d), and optionally one or more of the following components: e. from about 0.001% to 20% a confectionery sugar component if utilizing a chocolate or compound coating chocolate, by weight of the composition; f. from about 0.001% to 15% a crunchy texture ingredient component, by weight of the composition; g. at least about 0% or greater of a supplement selected from the group consisting of vitamins, minerals, herbs, botanicals, plant derived supplements, animal derived supplements, therapeutic compounds, and mixtures thereof; by weight of the composition; and h. at least about 0% or greater of an additional component selected from the group consisting of a flavor component, a filling component, a layer component, a color component, a preservative component, by weight of the composition

It is a further feature of an embodiment to provide a method of making a fiber-containing chocolate composition comprising: a. melting a standardized or compound coating chocolate or white chocolate component, and tempering it in a confectionery melting and tempering machine that also can be the mixing vessel, or then optionally placing the melted and tempered chocolate or white chocolate component into a mixing vessel; b. adding a fiber component to the melted and tempered chocolate or white chocolate component in the mixing vessel; c. adding at least one plant based edible oils component to the mixing vessel, and mixing the components in the mixing vessel until the group of component ingredients are blended into a homogeneous mixture, thereby creating a fiber containing chocolate composition. In accordance with additional features of preferred embodiments, the method optionally further comprises: d. adding 100% Cocoa Powder; e. adding a confectionery sugar component; f. adding a crunchy component; g. adding a supplement component, and mixing until the group of ingredients are blended into a homogeneous mixture; thereby creating the fiber containing chocolate composition.

In accordance with another feature of an embodiment, there is provided a method of making a fiber containing chocolate composition comprising: a. melting a standardized or compound coating chocolate or white chocolate component and tempering it in a confectionery melting and tempering machine that also can act as the mixing vessel, or then optionally placing the melted and tempered chocolate or white chocolate component into a mixing vessel that can maintain the chocolate or white chocolate component at a temperature of about 33° C. or higher so that the additional ingredients can be added and the chocolate or white chocolate component stays in a tempered condition; b. adding a fiber component to the melted and tempered chocolate or white chocolate component in the mixing vessel while continuously mixing the mixture; c. adding a plant based edible oils component in a liquid form at a temperature of about 33° C. or higher so that it does not affect the already tempered chocolate or white chocolate component, and mixing the components in the mixing vessel until the group of component ingredients are blended into a homogeneous mixture, thereby creating a fiber containing chocolate composition. In accordance with additional features of preferred embodiments, the method optionally further comprises: d. adding a 100% Cocoa Powder; e. adding a confectionery sugar component while continuously mixing the mixture; f. adding a crunchy component; g. adding a supplement component to the mixing vessel; h. adding a flavor component and a preservative component, and mixing at a temperature of 33° C. or higher until the mixture becomes homogeneous so that the chocolate or white chocolate component stays properly tempered; and i. adding an additional component selected from the group consisting of a filling component or a layer component and one shot depositing or layering processing the filling or layer.

The present inventors discovered that the compositions of the embodiments have a unique ability to maintain structure at high temperature levels, when compared to conventional standardized or compound coating chocolate or white chocolate products. Normal standardized or compound coating chocolate would turn into liquid at certain temperatures that occur with standard food and pharmacy product distribution channels and this would create a substantial difficulty in eating the product once it has melted; thus, requiring refrigerated or climate controlled delivery. Compositions prepared in accordance with the embodiments described herein maintain their structure even at temperatures substantially higher than those that occur within standard food and pharmacy distribution channels. This specific ability to maintain product structure at temperatures substantially higher than the melting point of regular standardized or compound coating chocolate and conditions that would arise in normal regular food and pharmacy product type distribution networks precludes the necessity for refrigeration or climate controlled distribution.

In the examples, the inventors directed a consumer survey, the results of which are shown in FIGS. 1 and 2, which demonstrates superior product performance versus the current leading Dr. recommended psyllium fiber supplement on all products attributes which will encourage ongoing consumer compliance with Dr. directed fiber supplementation. (Taste, Mouth Feel, Appearance, Flavor, After Taste, Ease of Taking, Ease of Swallowing, Convenience)

### BRIEF DESCRIPTION OF THE DRAWINGS

FIG. 1 is a bar graph illustrating the results of a consumer taste test survey comparing the dietary chocolate fiber-containing composition of the present embodiments with the leading commercially available fiber products.

FIG. 2 is a spyder graph illustrating the results of a consumer taste test survey comparing the dietary chocolate fiber-containing composition of the present embodiments with the leading commercially available fiber products.

### DETAILED DESCRIPTION

All percentages and ratios are calculated by weight unless otherwise indicated. All percentages and ratios are calculated based on the total final composition unless otherwise indicated. Referenced herein may be trade names for components including various ingredients utilized in the embodiments. The inventors herein do not intend to be limited by materials under a given trade name. Equivalent materials (e.g., those obtained from a different source under a different name or reference number) to those referenced by trade name may be substituted and utilized in the embodiments.

As used herein “fiber” generally denotes a material derived from plant cell walls and which is not digestible by human digestive enzymes, including soluble fiber and insoluble fiber. The fiber component can be naturally derived or synthetic. A portion of the fiber component can be non-starch polysaccharides, including soluble and non soluble fiber. As used herein “soluble fiber” denotes plant gums and oligosaccharides, or modified gums, modified celluloses, non-starch polysaccharides that are soluble in water, some of which can form viscous gels.

Generally, psyllium fiber has proven to be difficult to incorporate into fiber supplement compositions and products. The propensity of psyllium fiber to absorb water has made it difficult to create good tasting and effective delivery methods for psyllium. Proctor & Gamble created a patented smooth texture milled psyllium fiber that disperses well in water and psyllium based wafers that deliver an effective amount of psyllium. These two delivery methods both have problems. The psyllium fiber drink requires inconvenient mixing and users complain of poor taste, poor mouth feel and poor after taste. (See the consumer study in the Examples). The psyllium also turns to gel if the drink isn't finished in a short period of time. The psyllium based wafers have better taste, but become extremely dry when swallowing and leave a paste that collects in the mouth.

The aspect of psyllium fiber turning to gel appears to have plagued prior art and currently affects the effectiveness of the two current Proctor & Gamble psyllium fiber products. Creating a delivery method for a psyllium fiber-based supplement, which would be convenient, pleasant to eat and swallow was not possible until the present inventors discovered such products could be manufactured by adding whole psyllium fiber husks to the inventors's unique changed structure of chocolate compositions. The fiber containing compositions herein described work well as a delivery method for psyllium because chocolate or a compound coating chocolate has very low moisture and does not cause the psyllium fiber to turn to a gel. While not intending on being bound by any theory of operation, the inventors believe that chocolate or a compound coating chocolate acts as a coating and actually agglomerates the psyllium fiber within the composition, which allows the psyllium fiber to be easily swallowed.

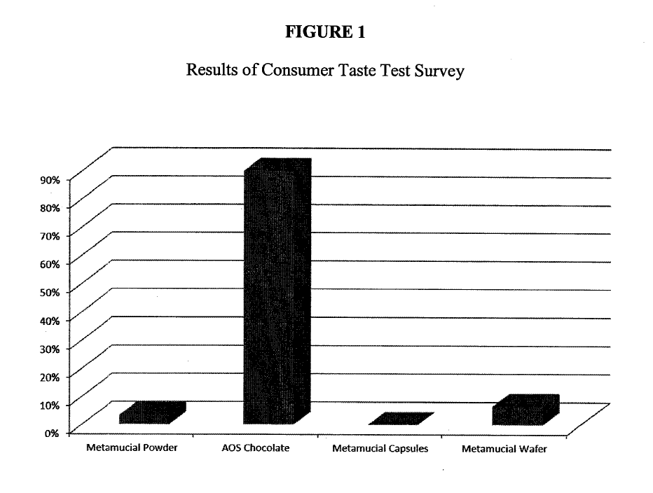

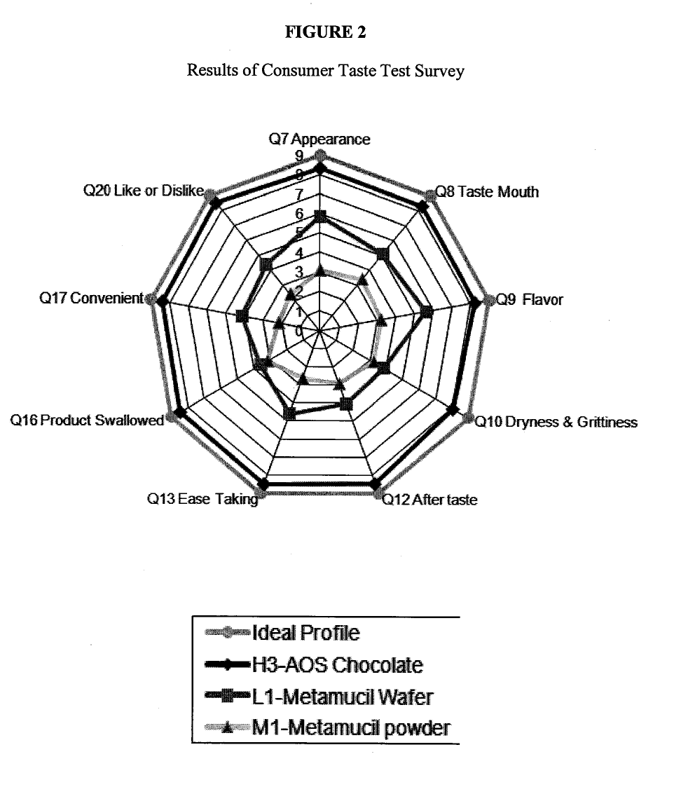

Various preferred embodiments of the invention can create psyllium fiber-based supplements that eliminate the potential for choking. This represents a significant departure from the commercially available psyllium fiber wafers in which the psyllium fiber absorbs moisture and saliva in the mouth and makes it hard to swallow to the point of possibly creating a choking hazard. This fiber paste tends to collect on the gums and cracks of the mouth. The fiber compositions of the preferred embodiments described herein exhibit excellent taste characteristics as the chocolate or compound coating chocolate melts in the mouth and thus promotes ease of swallowing the psyllium fiber. The examples include a survey that was completed comparing the present chocolate or compound coating chocolate-based psyllium fiber supplement and delivery method with the existing Proctor & Gamble smooth textured psyllium fiber powder drink and delivery method, psyllium fiber wafers and delivery method, and psyllium fiber capsules and delivery method. The bar graph and spider graph of FIGS. 1 and 2 clearly show the preference and consumer superiority of the present chocolate or compound coating chocolate-based fiber composition fiber supplement and delivery method, when compared to the conventional products and delivery methods.

Another aspect of the embodiments is that the fiber containing compositions described herein can have nutritional content that allows for the compositions to be physician recommended. Physician offices are a primary way that over-the-counter fiber supplements are prescribed for certain conditions such as constipation, digestion problems, high cholesterol, etc. Certain preferred embodiments contain combinations of the ingredients that enable the creation of a dark chocolate fiber supplement with a serving size of 17 grams that has 28% of a fiber component added to the composition and a total fat content of 5 grams with 2 grams of saturated fat, 1.5 grams of monounsaturated, and 1.5 grams of polyunsaturated fat. Other preferred embodiments contain combinations of ingredients that enable the creation of combinations of standardized or compound coating (milk and dark chocolate, high cocoa dark chocolate, chocolate, and white chocolate) fiber supplements with a serving size of 17 grams. In certain preferred embodiments, the fiber compositions can provide nutritional profiles that have 4 grams of total fat, 1 gram of saturated fat, and 1.75 grams of whole psyllium husks per dose that allows the product to carry the FDA approved claim of “Heart Healthy.” These additional flavors of compositions exhibit nutritional profiles similar to the above described dark chocolate fiber supplement and meet the nutritional requirements to qualify as “physician's recommend” as fiber supplements and can potentially have the same nutritional structure of 4 grams of total fat, 1 gram of saturated fat, and 1.75 grams of whole psyllium husk per dose that allows the products to carry the FDA approved claim of “Heart Healthy.”

Standardized or compound coating chocolate or white chocolate as the base for the fiber supplement or fiber laxative or fiber food readily accommodates bulk-forming fibers such as psyllium without the problem of the fiber absorbing moisture within the delivery medium. Some of the known compositions comprising psyllium husks, such as the Moskowitz patent discussed previously, provide chocolate flavored compositions, and not a chocolate composition like the chocolate compositions created in the present embodiments. Another significant difference is that the present invention adds additional components to the compositions that improve the nutritional profile and taste of the fiber-containing compositions and significantly improves the stability of the compositions to provide much higher structure temperature stability. Certain compositions within the preferred embodiments can meet these guidelines and can be the first chocolate composition to claim heart healthy status.

Normal Dark Chocolate has a serving size of about 40 grams and would have a total fat content of 13 grams with 8 to 12 grams of saturated fat, 4.5 to 8.5 grams of monounsaturated fat, and 0.5 to 1 grams of polyunsaturated fat. The 8 to 12 grams of saturated fat or 62% and above saturated fat per serving in normal dark chocolate is too high to be a healthy suggested food for many physicians. Even though Dark Chocolate has proven health benefits to the circulatory system and is high in antioxidants, many physicians would not prescribe eating it regularly because of this high saturated fat content and high sugar level. The fiber-containing compositions described herein can provide a nutritional structure that can be physician recommended, like many fiber supplements currently available. One embodiment of the dietary chocolate fiber-containing compositions described herein has 75% less saturated fat per serving, based on the 2 grams of saturated fat in a 17 gram fiber supplement, compared to the 8 grams of saturated fat in the 40 gram regular dark chocolate serving size. This ability to have the dietary chocolate fiber-containing compositions described herein prescribed and recommended by physicians is an important advantage of the invention.

The present inventors discovered that a composition comprising at least about 20% of a fiber component, by weight of the composition; at least 40% of a standardized or compound coating chocolate or white chocolate component, by weight of the composition; and from about 0.001% to 15% of an edible oil component by weight of said composition, can provide these advantages and features. Preferred compositions also may contain: from about 0.001% to 20% a 100% of a Cocoa Powder component if utilizing a chocolate or compound coating chocolate; from about 0.001% to 20% of a confectionery sugar component if utilizing a chocolate or compound coating chocolate; from about 0.001% to 15% of a crunchy component; and at least 0% or greater of a supplement component, and a flavor, a filling, a layer, a colorant, or a preservative component or combinations thereof.

### Fiber Component

The composition of the preferred embodiments comprises at least about 20%, alternately at least about 25%, alternately at least about 30%, alternately at least about 35%, alternately at least about 40%, alternately at least about 45%, alternately at least about 50%, alternately at least about 55%, and alternately at least about 59%, of a fiber component, by weight, of the composition. Non-limiting examples of fiber components useful in the embodiments include, but are not limited to naturally derived soluble fiber; naturally derived inulin; inulin extract; synthetic inulin; hydrolysis products of inulin commonly known as fructooligosaccharides, galacto-oligosaccharides, xylooligosaccharides, or oligo derivatives of starch; husks; brans; psyllium; polysaccharides; oligosaccharides; celluloses and derivatives thereof; starches, modified starches, and derivatives of starches; polycarbophil; lignin; arabinogalactans; chitosans; oat fiber; soluble corn fiber; non-digestible corn or wheat dextrin; locust bean gum and derivatives thereof; hydroxypropylmethyl cellulose (HPMC); pectin; and mixtures thereof. In a preferred embodiment, the fiber component is a blend of naturally derived inulin and whole psyllium husks. The whole psyllium fiber husk is no less than 95% purity. In certain other embodiments, the compositions may be comprised of only whole psyllium husks, or only with inulin.

### Standardized or Compound Coating Chocolate or White Chocolate Component

A preferred embodiment comprises a standardized chocolate or compound coating chocolate or white chocolate component, which comprises at least 40%, alternatively at least 45%, alternatively at least 50%, alternatively at least 55%, alternatively at least 60%, alternatively at least 65%, alternatively at least 70%, alternatively at least 75%, alternatively at least 79%, of a chocolate or white chocolate component, by weight, of the composition. “Standardized chocolate” as it is used herein, denotes chocolates, (milk, semi-sweet, bitter-sweet, dark), and white chocolates that satisfy the FDA standards. As is known in the art, “compound coating chocolate” or “compound coating white chocolate,” as the case may be, denotes a less-expensive non-chocolate product replacement made from a combination of cocoa, vegetable fat, and sweeteners. Non-limiting examples of suitable standardized chocolate or compound coating chocolate or white chocolate components include standardized milk chocolate, semi-sweet chocolate, bittersweet chocolate, white chocolate, or a compound coating milk chocolate, compound coating semi-sweet chocolate, compound coating bittersweet chocolate, or compound coating white chocolate and artificial sugar or natural sugar substitute sweetener forms of the previous suitable chocolate, white chocolate, or compound coating components or combinations of them. Non-limiting examples of natural sweeteners include sugars and starches such as sucrose, glucose, fructose, lactose, maltose, corn starch, and mixtures thereof. Non-limiting examples of artificial sweeteners include sucralose, acesulfame potassium, aspartame, saccharin, lactitol, stevia, Neohesperidine DC, polydextrose, cyclamates, sugar alcohols, isomalt, and mixtures thereof.

The standardized chocolate or white chocolate, or the compound coating chocolate or white chocolate component can be a mixture of chocolate components such as for example, the chocolate component can be a mixture of standardized milk chocolate and semi-sweet chocolate present in the chocolate component in a weight ratio within the range of from about 1:2 to 1:3 to 1:4.

### Edible Oil Component

The preferred embodiments also comprise an edible oil component, which comprises from about 0.001% to 15% by weight of the composition, alternatively 0.001% to 5%, alternatively 5% to 10%, alternatively 10% to 15% of an edible oil component, by weight, of composition. Non-limiting examples of the edible oils component includes a plant source edible oil with a high saturated fat content and a plant source edible oil with a low saturated fat content that includes mostly unsaturated fats. The edible oils component with high saturated fat content preferably is derived from the group of fats including; coconut oil, palm kernel oil, or fractionated oils from high saturated fat oils. The edible oils component with a low saturated fat content that includes mostly unsaturated fats preferably is selected from the group of oils including; canola oil, soybean oil, safflower oil, sunflower oil, sesame oil, walnut oil, olive oil, flaxseed oil, chia seed oil, almond oil, corn oil, grape seed oil, peanut oil, other nut oils, and combinations thereof.

Optionally, embodiments of the compositions also may include the edible oils component that includes a plant source edible oil with a high saturated fat content to be replaced with oils that have been chemically altered that include partially hydrogenated oils, fully hydrogenated oils, or a chemically created fat replacement that has the same taste, texture, and mouthfeel properties as a plant source edible oil with a high saturated fat content.

### 100% Cocoa Powder Component

The preferred embodiments that utilize standardized chocolate or a compound coating chocolate optionally include a 100% Cocoa Powder component, which comprises from about 0.001% to 20% by weight of the composition, alternatively 0.001% to 5%, alternatively greater than 5% to 10%, alternatively greater than 10% to 15%, alternatively greater than 15% to 20% of a 100% Cocoa Powder component, by weight, of the composition. Non-limiting examples of suitable 100% Cocoa Powder components include low fat 100% cocoa, high fat 100% cocoa, and dutched 100% cocoa. Cocoa Powder that has a cocoa percentage less than 100% can be used in some embodiments, but this type of cocoa typically has a sweetner added to the cocoa in place of the 100% cocoa powder. The embodiments described herein optionally adds confectionery sugar as a separate ingredient and thus would not need a cocoa powder that has sugar as a component. If used, however, those skilled in the art would appreciate that the amount of sugar present in the less than 100% Cocoa Powder component could off-set the amount of confectionery sugar component.

### Confectionery Sugar Component

The preferred embodiments that utilize standardized chocolate or a compound coating chocolate also may optionally include a confectionery sugar component, which preferably comprises from about 0.001% to 20% by weight of the composition, alternatively 0.001% to 5%, alternatively greater than 5% to 10%, alternatively greater than 10% to 15%, alternatively greater than 15% to 20% of a confectionery sugar component, by weight, of the composition. Any confectionery sugar can be used as the confectionery sugar component, including commercially available confectionery sugar.

### Crunchy Component

The preferred embodiments that utilize standardized chocolate or a compound coating chocolate also may optionally include a crunchy component, which comprises from about 0.001% to 15% by weight of the composition, alternatively 0.001% to 5%, alternatively greater than 5% to 10%, alternatively greater than 10% to 15% of a crunchy component, by weight, of composition. Non-limiting examples of suitable crunchy components include crisp rice, crisp wheat, crisp corn, chia seeds, granola, nuts, or other seeds or grains that have a crunchy texture or mixtures thereof. Whey protein crisps, protein crisps, or other natural or artificial manufactured crunchy components also could be used to provide specific nutrients to the compositions described herein.

### Supplement Component

The preferred embodiments that utilize standardized chocolate or a compound coating chocolate also may optionally include at least about 0% or greater, by weight of the composition, of a supplement component including, but not limited to, vitamins, minerals, herbs, botanicals, plant derived supplements, animal derived supplements, therapeutic compounds, and mixtures thereof.

Non-limiting examples of such other components include: calcium, potassium, B vitamins, vitamins A, C, D, E, and K, folic acid, other vitamins and minerals commonly known in the art and used for supplementing the diet; extracts and active phytochemicals including ferulic acid (from apples), ginseng, ginko biloba, beta carotene, capsicanoids, anthocyanidins, bioflavinoids, d-limonene, isothiocyanates, cysteines from garlic, ginger, grapes, catechins and polyphenols from teas, onions, phytosterols, isoflavones, lycopene, curcumin, caffeine; glucosamine, chondroitin, msm; melatonin, seratonin; and mixtures thereof.

Alternatively, the composition can include from about 0% to about 25%, alternatively from about 0% to about 10%, and alternatively from about 0% to about 5%, by weight of the composition, of a supplement component.

### Flavor, Filling, Layer, Colorant and Preservative Components

Various additional components including natural and artificial flavors, natural and artificial sweeteners, and natural and artificial colorants and/or food grade dyes can be included in the compositions of the present invention. In addition, various preservatives, as would be understood by those of ordinary skill in the art can also be added. Non-limiting examples of flavors include natural or artificial flavors and include chocolate; vanilla; caramel; coffee; fruit flavors including lemon, lime, orange, blackberry, raspberry, blueberry, peach, apricot, cherry, grape; and mixtures thereof. Such flavors can be purchased, and/or prepared and added using known flavor technologies. Non-limiting examples of fillings include; fruit, peanut butter, caramel, marzipan, almond paste, nut pastes, chocolate compositions, etc. Non-limiting examples of layers include; fruit, nuts, granola, grains, grain blends, peanut butter, caramel, marzipan, almond paste, nut pastes, chocolate compositions, etc. Non-limiting examples of suitable preservatives include: sodium benzoate, sodium citrate, sodium phosphate, potassium metabisulfite, sodium metabisulfite, sodium lactate, sodium sulfite, EDTA (ethylenediaminetetraacetic acid), methylparaben, TBHQ, tocopherols, and mixtures thereof.

The compositions of the preferred embodiments may optionally include at least about 0.001%, by weight of the composition, of flavor, colorant and/or preservative components, and mixtures thereof. Alternatively, the compositions of the present invention can include from about 0.001% to about 10%, alternatively from about 0.001% to about 5%, and alternatively from about 0.001% to about 2%, by weight of the composition, of flavor, colorant components and/or mixtures thereof.

### Form of Composition

The preferred embodiments can be formed into any suitable, ingestible form. Non-limiting examples of the form of the compositions include: bite size pieces, squares or rectangles of specific weight, varying molded shapes or sizes that are available for chocolate confectionery products, nutritional and snack bars including any and all categories within the nutritional and snack bar category (meal replacement, diet, energy, protein, breakfast, etc.) at specific weights, clusters, individual unit dose, user-dosable form, and mixtures thereof that can be easily consumed as a supplement. An additional advantage of the form of the compositions are that the structure of the compositions maintain their shape at high temperatures that sometimes are part of everyday food and pharmacy distribution channels. This allows the compositions of the preferred embodiments to not require the necessity of refrigerated or climate control distribution channels.

### Method of Making

The compositions described herein can be made by mixing the respective components in a suitable mixing vessel to provide a homogeneous mixture, and then forming the mixture into the requisite product shape. Exemplary methods of preparing the compositions may include the following: Melting a standardized chocolate or a compound coating chocolate or white chocolate component and tempering the melted component in a confectionery melting and tempering machine that can act as the mixing vessel, or optionally adding an already melted and tempered standardized chocolate or compound coating chocolate or white chocolate to a mixing vessel that can maintain the standardized chocolate or compound coating chocolate or white chocolate component at a temperature of about 33° C. or higher so that the additional ingredients can be added and the standardized chocolate or compound coating chocolate or white chocolate component remains in a tempered condition. The method also includes adding a fiber component to the melted and tempered standardized chocolate or compound coating chocolate or white chocolate component in the mixing vessel while continuously mixing the mixture. The preferred method also entails adding a plant based edible oils component in a liquid form at a temperature of about 33° C. so that it does not affect the already tempered standardized chocolate or compound coating chocolate or white chocolate component.

The preferred embodiments also optionally include adding a 100% Cocoa Powder component if utilizing a chocolate or compound coating chocolate, (if white chocolate is utilized, the Cocoa Powder would not be added), adding a confectionery sugar component if utilizing a chocolate or compound coating chocolate, adding a supplement component while continuously mixing the mixture at a continuous 33° C. so that the standardized chocolate or compound coating chocolate or white chocolate component stays properly tempered until the mixture becomes homogeneous.

Further embodiments of the exemplary method include adding an additional component selected from the group consisting of a flavor component, a filling component, a layer component, a color component, a preservative component, and mixing until the mixture becomes homogeneous with the additional listed component, or one shot depositing the filling component or using a layering confectionery machine to add a layer within the composition.

The final mixture can either then be made using a traditional chocolate molding line, an extrusion can be carried out utilizing a standard confectionery extruder line based on the viscosity of the final compositions, or the final mixture can be sheeted and cut into unit doses or bars. All three manufacturing methods preferably include a cooling stage that allows the final compositions to have the proper standardized chocolate or compound coating chocolate set. The final compositions will either be made into molded squares or bars by the traditional chocolate molding line or cut into squares or bars using a standard confectionery extruder line or cut into squares or bars with a cutting device. The squares or bars produced by the three production methods can be flow wrapped into foil wrappers such as is standard for confectionery chocolate squares or bars in the industry. These packaged individual squares or bars can then be placed in secondary packaging, non-limiting examples including, but not limited to, glass bottles, plastic bottles, cartons, bags, pop boxes, or sleeves; and combinations thereof.

### Methods Of Using

Various preferred embodiments also include methods of delivering a safe and effective amount of a fiber component to a user. As used herein, a “safe and effective amount” denotes an amount of fiber component effective to deliver one or more of the following benefits: taxation; increased stool volume and moisture content; intestinal regularity; slowed gastrointestinal transition and digestion processes; modified fat absorption; aiding in weight management; increasing excretion of bile acids; aiding in lowering blood cholesterol; benefiting the postprandial glycemic response; aiding growth and/or development of beneficial gastrointestinal microorganisms; as well as helping to reduce the risk of heart disease, diabetes, obesity, and colon cancer. One preferred method of delivering a safe and effective amount of fiber component to a user comprises the user ingesting from about 1 to about 20 unit doses per day of a composition that includes at least about 20% of a fiber component by weight of the composition; at least about 40% by weight of a standardized chocolate or a compound coating chocolate or a white chocolate component, by weight of the composition; and from about 0.001% to 15% of an edible oil component by weight of said composition.

The composition may optionally contain one or more of the following components: from about 0.001% to 20% of a 100% Cocoa Powder component, if utilizing a chocolate or compound coating chocolate; from about 0.001% to 20% of a confectionery sugar component, if utilizing a chocolate or compound coating chocolate; from about 0.001% to 15% of a crunchy component; and at least 0% or greater of a supplement component, and a flavor, a filling, a layer, a colorant, or a preservative component, or combinations and mixtures thereof.

To deliver a desired amount of fiber component per day, a user can ingest from about 1 to about 20 unit doses, alternatively from about 1 to about 10 unit doses, and alternatively from about 1 to about 5 unit doses of the composition per day, i.e. for example, from about 1 to about 3 chocolate squares per day. Each unit dose can comprise from about 2 to about 12 grams of fiber component, and alternatively from about 2 to about 5 grams of fiber component. Therefore, for example, if a user wished to ingest 10 grams of fiber per day, the user would ingest about 2 squares. If the user wished to ingest 20 grams of fiber per day, the user would ingest about 4 unit doses per day.

All documents cited in the Detailed Description are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### EXAMPLES

The below examples are included for illustrative purposes only and are not intended to in any way limit the scope of the present invention.

### Example 1

At room temperature, 12.8 ounces of Tulsa Dark brand dark chocolate supplied by Barry Callebaut were added to a melting confectionery mixer that also tempered the chocolate. Then 3.2 oz. of a fiber component was added to the melted and tempered dark chocolate while continuously mixing the chocolate at least at about 33° C. to keep the mixture properly tempered and ready to move to the depositing stage until the mixture was homogeneous. The 3.2 oz. of a fiber component was comprised of 21% inulin fiber, and 79% whole psyllium husk, which translates to about 0.672 oz. of inulin (19 grams), and 2.528 oz. of whole psyllium husk (71.5 grams). To the mixture then were added 1.2 oz. of canola oil and 6 grams of virgin coconut oil, and 1 oz. of 100% Cocoa Powder, and 1 oz. of confectionery sugar. To this mixture then were added 1 oz. of crisp corn. The blended composition was then deposited in molds that make 17 gram squares and refrigerated for at least 40 minutes to allow the composition to set. The pieces then were ejected from the molds and flow wrap packaged in a standard confectionery packaging machine. The squares then were be packed into secondary packaging of a bag carton design containing 12 individual doses.

### Example 2

At room temperature, 12.8 ounces of Baker's White Chocolate brand white chocolate supplied by Kraft Foods were added to a melting confectionery mixer that also tempered the chocolate. Then, 3.2 oz. of a fiber component was added to the melted and tempered white chocolate while continuously mixing the chocolate at least at about 33° C. to maintain the mixture properly tempered and ready to move to the depositing stage until the mixture was homogeneous. The 3.2 oz. of a fiber component included 21% inulin and 79% whole psyllium husk, which translates to about 0.672 oz. of inulin (19 grams), and 2.528 oz. of whole psyllium husk (71.5 grams). To the mixture then were added 1 oz. of canola, and 6 grams of virgin coconut oil. To this mixture, 0.5 oz. of chia seeds and 0.5 oz. of crisp rice were added and blended. The blended composition then was deposited in molds to produce 17 gram squares, and refrigerated for at least 40 minutes to allow the composition to set. The pieces were then ejected from the mold and flow wrap packaged in a standard confectionery packaging machine. The squares then were packed into secondary packaging of a bag carton design containing 12 individual doses.

### Example 3

At room temperature, 12.8 ounces of Tulsa Dark brand dark chocolate supplied by Barry Callebaut were added to a melting confectionery mixer that also tempered the chocolate. Then 4.5 oz. of a fiber component was added to the melted and tempered dark chocolate while continuously mixing the chocolate at least at about 33° C. to keep the mixture properly tempered and ready to move to the depositing stage until the mixture was homogeneous. The 4.5 oz. of a fiber component included 21% inulin and 79% whole psyllium husk, which translates into about 0.95 oz. of inulin and 3.55 oz. of whole psyllium husk. To the mixture, then were added 2.1 oz. of an edible oil component, which was comprised of 1.61 oz. of a vegetable oil blend made up of mostly unsaturated fats (available from Smart Balance that contains a blend of canola, soy, and olive oil), and 0.485 oz. of an edible oil with a high saturated fat (available as Green Label Virgin Coconut Oil from Tropical Traditions). To the mixture then were added 1.2 oz. of 100% Cocoa Powder (available from Nestle), and 0.95 oz. of confectionery sugar. About 14 grams of a flavor component (available as pure vanilla powder from Cook's Flavoring Company) were added to the mixture, and then 0.62 grams of tocopherols or 0.001% of total composition weight of a natural preservative (available from Gillco) were added.

The mixture then was continuously mixed at about 33° C. until the mixture was homogeneous. The blended composition was then deposited in molds that made 17 gram squares, and refrigerated for at least 40 minutes to allow the composition to set. The pieces then were ejected from the mold and flow wrap packaged in a standard confectionery packaging machine. The squares then were packed into secondary packaging of a bag carton design containing 12 individual doses.

### Example 4

At room temperature, 12.8 ounces of Tulsa Dark brand dark chocolate supplied by Barry Callebaut were added to a melting confectionery mixer that also tempered the chocolate. Then 5.5 oz. of a fiber component were added to the melted and tempered dark chocolate while continuously mixing the chocolate at least at about 33° C. to keep the mixture properly tempered and ready to move to the depositing stage until the mixture was homogeneous. The 5.5 oz. of a fiber component included 21% inulin and 79% whole psyllium husk, which translates to about 1.15 oz. of inulin and 4.3 oz. of whole psyllium husk. To this mixture then were added 2.1 oz. of an edible oil component, which was comprised of about 1.61 oz. of a vegetable oil blend made up of mostly unsaturated fats (available from Smart Balance that contains a blend of canola, soy, and olive oil), and about 0.485 oz. of an edible oil with a high saturated fat (available as Green Label Virgin Coconut Oil from Tropical Traditions). To this mixture then were added 1.2 oz. of 100% Cocoa Powder (available from Nestle), and 0.95 oz. of confectionery sugar. To this mixture then were added 3.2 oz. of a crunchy component that consisted of 1.48 oz. of chia seeds (available from Renew Life) and 1.71 oz. of crisp rice (available from Wal-Mart Great Value brand).

Additional components then were added as follows: 5.2 grams of a supplement component that included 4 grams of blackberry powder (available from Decas Botanicals) and 1.2 grams of acai berry powder (available from Sambazon); 14 grams of a flavor component (available as pure vanilla powder from Cook's Flavoring Company); and 0.75 grams of tocopherols or 0.001% of total composition weight a natural preservative (available from Gillco). The mixture then was continuously mixed at about 33° C. until the mixture was homogeneous. The blended composition then was extruded and cut into 17 gram squares, and refrigerated for at least 40 minutes to allow the composition to set. The pieces were then flow wrap packaged in a standard confectionery packaging machine. The squares then were packed into secondary packaging of a bag carton design containing 12 individual doses.

### Example 5

At room temperature, 12.8 ounces of Baker's White Chocolate brand white chocolate supplied by Kraft Foods were added to a melting confectionery mixer that also tempered the chocolate. Then, 6.92 oz. of a fiber component was added to the melted and tempered white chocolate while continuously mixing the chocolate at least at about 33° C. to keep the mixture properly tempered and ready to move to the depositing stage until the mixture was homogeneous. The 6.92 oz. of a fiber component was comprised of 30.6% inulin and 70.4% whole psyllium husk, which translates to 2.12 oz. of inulin, and 4.87 oz. of whole psyllium husk. To this mixture then were added 1.6 oz. of an edible oil component, which included 1.35 oz. of a vegetable oil blend made up of mostly unsaturated fats (available from Smart Balance that contains a blend of canola, soy, and olive oil), and 0.24 oz. of an edible oil with a high saturated fat (available as Green Label Virgin Coconut Oil from Tropical Traditions).

The following also were added to the mixture: 3.2 oz. of a crunchy component that includes 1.48 oz. of chia seeds (available from Renew Life) and 1.71 oz. of crisp rice (available from Wal-Mart Great Value brand); 8.5 grams of a flavor component (available as pure vanilla powder from Cook's Flavoring Company); and 0.7 grams of tocopherols or 0.001% of total composition weight a natural preservative (available from Gillco). The mixture then was ontinuously mixed at about 33° C. until the mixture was homogeneous. The blended composition then was extruded and cut into 17 gram squares and refrigerated for at least 40 minutes to allow the composition to set. The pieces were then flow wrap packaged in a standard confectionery packaging machine, and the squares packed into secondary packaging of a bag carton design containing 12 individual doses.

### Example 6

At room temperature, 10.2 ounces of Tulsa Dark brand dark chocolate supplied by Barry Callebaut and 2.6 ounces of Natural Milk 823 supplied by Barry Callebaut were added to a melting confectionery mixer that can also temper the chocolate. To this mixture then were added 5.5 oz. of a fiber component while continuously mixing the chocolate at least about 33° C. to keep the mixture properly tempered and ready to move to the depositing stage until the mixture is homogeneous. The 5.5 oz. of a fiber component was comprised of 21% inulin and 79% whole psyllium husk, which translates into 1.15 oz. of inulin and 4.3 oz. of whole psyllium husk. To this mixture then were added 2.1 oz. of an edible oil component, which was comprised of 1.61 oz. of a vegetable oil blend made up of mostly unsaturated fats (available from Smart Balance that contains a blend of canola, soy, and olive oil), and 0.485 oz. of an edible oil with a high saturated fat (available as Green Label Virgin Coconut Oil from Tropical Traditions).

The following components also were added to the mixture: 1.2 oz. of 100% Cocoa Powder (available from Nestle); 0.95 oz. of confectionery sugar; 3.2 oz. of a crunchy component that includes 1.48 oz. of chia seeds (available from Renew Life) and 1.71 oz. of crisp rice (available from Wal-Mart Great Value brand); 5.2 grams of a supplement component that includes 4 grams of blackberry powder (available from Decas Botanicals) and 1.2 grams of acai berry powder (available from Sambazon); 14 grams of a flavor component (available as pure vanilla powder from Cook's Flavoring Company); 0.75 grams of tocopherols or 0.001% of total composition weight a natural preservative (available from Gillco). The mixture then was continuously mixed at about 33° C. until the mixture was homogeneous. The blended composition then was extruded and cut into 17 gram squares and refrigerated for at least 40 minutes to allow the composition to set. The pieces were then flow wrap packaged in a standard confectionery packaging machine, and the squares then packed into secondary packaging of a bag carton design containing 12 individual doses.

Examples 1 thru 3 are compositions that can be manufactured using traditional molding confectionery production lines and example 4 thru 6 are compositions that would be manufactured using traditional extruder confectionery production lines or a sheeting method. The viscosity of the final fiber containing compositions determines the specific type of manufacturing—either the traditional molding confectionery line or the extruder confectionery production line or sheeting production. The packaging and secondary packaging of the squares or bars would be the same.

### Example 7

A consumer taste test survey was conducted to compare the product performance of the dietary chocolate fiber-containing composition against the current leading Dr. recommended psyllium fiber supplement on all products attributes. Specifically, the dietary chocolate fiber-containing composition was prepared as described below and compared with the following commercially available fiber supplement products: Metamucil powder; Metamucil wafers; and Metamucil capsules.

The dietary chocolate fiber-containing composition was comprised of the following ingredients:

15.1 oz. Callebuat 53.8% Dark Chocolate

15 g Cook's Vanilla Powder

10 g Spectrum Virgin Coconut Oil

2.5 oz. Metamucil Clear & Natural Inulin

3.55 oz. Yerba Prima Whole Psyllium Husk

3.55 oz. Yerba Prima Whole Psyllium Husk Powder

1.8 oz. Crisco Canola Oil

1.4 oz. Nestle 100% Cocoa Powder

1.1 oz. Dixie Crystals Confectionery Sugar

2 oz. Kellogg's Rice Crispies

1.75 oz. Frontier Natural Co-op Chia Seeds

Approximately 13.1 oz. of the Callebuat 53.8% Dark Chocolate was melted in a large glass mixing bowl in the microwave. The chocolate was microwaved for 30 seconds twice and 15 seconds a third time. The melted Callebaut 53.8% dark chocolate was then mixed until completely fluid. 2 oz. of finely chopped 518% Callebuat dark chocolate was then added to the mixing bowl and the chocolate was slowly mixed until all the finely chopped chocolate melted into the original chocolate. This process took about 5 minutes, and when the finely chopped chocolate was melted into the mixture it was continuously mixed with a spatula, which lowered the temperature to about 88 to 92° F. The 15.1 oz. of Callebaut 53.8% Dark Chocolate then was tempered, and 10 g Spectrum Virgin Coconut Oil, 1.8 oz. of Crisco Canola Oil, and 15 g of Cook's Vanilla Powder was mixed into the chocolate for 5 minutes. Then, 1.4 oz. of Nestle 100% Cocoa Powder, and 1.1 oz. of Dixie Crystals Confectionery Sugar was blended into the chocolate using a whisk for 3 minutes. About 2.5 oz. of Metamucil Clear & Natural Inulin, 3.55 oz. Yerba Prima Whole Psyllium Husk, and 3.55 oz. Yerba Prima Whole Psyllium Husk Powder was then blended into the chocolate for 3 minutes. Then 2 oz. of Kellogg's Rice Crispies and the 1.75 oz. of Frontier Natural Co-op Chia Seeds was blended into the chocolate for 5 minutes to ensure the chocolate mixture was homogeneous.

The dark chocolate fiber supplement formula made above then was spread into a small cookie sheet that had Glad Cling Wrap covering its surface. The mixture was spread out into all the corners and made level. The small cookie sheet then was banged against a countertop to push the chocolate mixture out completely even into all the corners and to create the sheen that chocolate usually has on its surface. The tray of dark chocolate fiber supplement formula was then refrigerated for 25 minutes to allow the chocolate to set. The chocolate was then taken out of the cookie sheet and placed on a large cutting board. The chocolate formula was then cut into bite size pieces that was used in the consumer taste study.

Thirty participants (95% confidence factor for the sample size) were asked to taste the dietary chocolate fiber-containing compositions of the present embodiments (labeled AOS Chocolate in the Figures) and rate the attributes of the product and compare them with the same attributes of an orange Metamucil fiber drink (powder), a Metamucil fiber capsule, and a Metamucil fiber wafer. The taste test lasted about 10-15 minutes per participant. The participants were 40% female and 60% male, >60% of the participants were 30 years of age or older (43% were 40+), 57% of the participants normally consumed a fiber supplement, and >53% of the participants used fiber once a week or more (43% used fiber once a day or more).

The results of the taste test survey are shown in FIGS. 1 and 2. FIG. 1 reveals that the dietary chocolate fiber-containing compositions provided a fiber delivery preference far superior to any of the Metamucil comparative samples, achieving greater than 80% fiber delivery preference, whereas the closest Metamucil fiber supplement delivered less than 10% fiber delivery preference. FIG. 2 is a spider graph comparing a sensory analysis of the inventive dietary chocolate fiber-containing compositions to the Metamucil fiber supplements (wafer and powder). The participants were asked a series of questions after tasting each product, and provided answers on a scale from 0 to 10, with 0 being the worst and 10 being the best. FIG. 2 reveals that the inventive dietary chocolate fiber-containing compositions significantly out-performed the Metamucil fiber supplements in 9 sensory questions. For example, the participants gave the inventive compositions a score of 8 for taste in the mouth, when compared to 5 for the Metamucil wafer and only about 3 for the Metamucil powder. Similarly, the participants gave the inventive compositions a score of about 9 when asked whether they liked the product (question 20), when compared to about 4 for the Metamucil wafer, and only about 1 for the Metamucil powder.

The taste test survey reveals that consumers clearly prefer the dietary chocolate fiber-containing compositions described herein both for fiber delivery preference, and in a sensory analysis, when compared to commercially available fiber supplements.

What is claimed is:

1. A dietary chocolate fiber-containing composition comprising:
(a) at least about 20% by weight of a fiber component;
(b) at least 40% by weight of a standardized chocolate, a compound coating chocolate component,
or a standardized white chocolate; and
(c) from about 0.001% to 15% of an edible oil component.

2. The dietary chocolate fiber-containing compositions as claimed in claim 1, further comprising one or more of the following: (d) from about 0.001% to 20% by weight of a 100% Cocoa Powder component; (e) from about 0.001% to 20% by weight of a confectionery sugar component; (f) from about 0.001% to 15% by weight of a crunchy component; and (g) at least 0% by weight of a supplement component.

3. The composition of claim 1, wherein the fiber component is selected from the group consisting of: naturally derived soluble fiber; naturally derived inulin; inulin extract; synthetic inulin; hydrolysis products of inulin selected from fructooligosaccharides, galacto-oligosaccharides, xylooligosaccharides, and oligo derivatives of starch; husks; brans; psyllium; polysaccharides; starches; polycarbophil; lignin; arabinogalactans; chitosans; oat fiber; soluble corn fiber; non-digestible corn dextrin; non-digestible wheat dextrin; locust bean gum and derivatives of locust bean gum; hydroxypropylmethyl cellulose (HPMC); pectin; and mixtures and combinations thereof.

4. The composition of claim 3 wherein the fiber component is present in an amount from about 20% to about 59% by weight of the composition.

5. The composition of claim 3 wherein the fiber component is a mixture of inulin and psyllium.

6. The composition of claim 1, wherein the standardized chocolate, compound coating chocolate, or standardized white chocolate is selected from the group consisting of standardized or compound coating milk chocolate, semi-sweet chocolate, bittersweet chocolate, white chocolate, and mixtures and combinations thereof.

7. The composition of claim 1, wherein the standardized chocolate, compound coating chocolate, or white chocolate is present in an amount of from about 40% to about 79%, by weight of the composition.

8. The composition of claim 1, wherein the edible oil component is present in an amount of from about 0.001% to 15% by weight, based on the weight of the composition.

9. The composition of claim 8, wherein the edible oil component comprises a plant source edible oil with a high saturated fat content and a plant source edible oil with a low saturated fat content that includes mostly unsaturated fats.

10. The composition of claim 9, wherein the edible oil component having a high saturated fat content is selected from the group consisting of coconut oil, palm kernel oil, fractionated oils from high saturated fat oils, and mixtures thereof.

11. The composition of claim 9, wherein the edible oil component having a low saturated fat content that includes mostly unsaturated fats is selected from the group consisting of canola oil, soybean oil, safflower oil, sunflower oil, sesame oil, walnut oil, olive oil, flaxseed oil, chia seed oil, almond oil, corn oil, grape seed oil, peanut oil, other nut oils, and combinations and mixtures thereof.

12. The composition of claim 2, wherein the 100% Cocoa Powder component is present in an amount of from about 0.001% to 20% by weight, based on the weight of the composition.

13. The composition of claim 2, wherein the confectionery sugar component is present in an amount of from about 0.001% to 20% by weight, based on the weight of the composition.

14. The composition of claim 2, wherein the crunch component is present in an amount of from about 0.001% to 15% by weight, based on the weight of the composition.

15. The composition of claim 14, wherein the crunchy component is selected from the group consisting of crisp rice, crisp wheat, crisp corn, chia seeds, granola, nuts, or other seeds or grains that have a crunchy texture, whey protein crisps or protein crisps, natural or artificially made crunchy component, and mixtures thereof.

16. The composition of claim 15, wherein the crunchy component comprises a mixture of crisp rice and chia seeds in a weight ratio of around 1:0.5 to 1:0.85.

17. The composition of claim 1, wherein the composition is present in a form selected from the group consisting of: bite size pieces; squares or rectangles of specific weight; varying molded shapes or sizes that are available for chocolate confectionery products; nutritional and snack bars; clusters; individual unit dose; user-dosable forms; and mixtures and combinations thereof.

18. A method of delivering a safe and effective amount of fiber component to a user comprising: 1) providing to the user from about 1 unit dose to about 20 unit doses per day of a composition comprising: (a) at least about 20% by weight of a fiber component; (b) at least 40% by weight of a standardized chocolate, a compound coating chocolate component, or a standardized white chocolate; and (c) from about 0.001% to 15% of an edible oil component; and
2) depending on the level of fiber within the dose, providing the user with at least 8 ounces of water.

19. The method of claim 18 wherein the unit dose comprises from about 1 to 15 grams of said fiber component.

20. A method of preparing a dietary chocolate fiber-containing composition comprising: (a) melting a chocolate selected from the group consisting of standardized chocolate, white chocolate, or a compound coating chocolate, and tempering the melted chocolate in a confectionery tempering vessel to provide, a melted and tempered chocolate component; (b) optionally placing the melted and tempered chocolate component into a mixing vessel; (c) adding a fiber component to the melted and tempered chocolate component in the mixing vessel; (d) adding an edible oils component to the mixing vessel; and (e) mixing until the group of ingredients are blended into a homogeneous mixture, thereby creating the dietary chocolate fiber-containing composition.

21. The method of claim 20, further comprising, prior to (e), optionally adding one or more of the components selected from the group consisting of: a 100% Cocoa Powder component when a standardized chocolate or compound coating chocolate is added; a confectionery sugar component when a standardized chocolate or compound coating chocolate is added; a crunchy component; and a supplement component.

22. The method of claim 20, wherein the chocolate is melted at a temperature of more than about 33° C., and the confectionery tempering vessel or optional mixing vessel is maintained at a temperature of more than about 33° C. until the final mixture is blended to into a homogeneous mixture.
